(19) United States
(12) Patent Application Publication
(10) Pub. No.: US 2008/0068964 A1
(43) Pub. Date: Mar. 20, 2008

(54) OPTICAL INFORMATION RECORDING MEDIUM AND DISPLAY METHOD THEREFOR

(75) Inventors: Hidenori Somei, Gunma (JP); Satoshi Kobayashi, Gunma (JP); Aiko Amano, Gunma (JP); Eiji Yamada, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 11/832,538

(22) Filed: Aug. 1, 2007

(30) Foreign Application Priority Data
Aug. 2, 2006 (JP) 2006-232769

(51) Int. Cl. G11B 3/74

(52) U.S. Cl. 369/94

(57) ABSTRACT

An optical information recording medium having a drawing region capable of being used without being reversed and without interference with a data recording region is disclosed. The optical information recording medium has a structure in which a recording layer, a semitransparent reflective layer, a discoloration layer, and a protective layer are is formed in order on a first light-transmitting substrate so that the discoloration layer is irradiated with a laser beam to change the optical property of the discoloration layer. For example, interaction between a colorant and a developer in the discoloration layer which assumes a black color is eliminated to cause the color to disappear, thereby forming an image.

### BACKGROUND OF THE INVENTION

1. Field of the Invention

The present invention relates to an optical information recording medium such as DVD±R and particularly to an optical information recording medium having a structure capable of drawing by laser irradiation and a drawing display method therefor.

2. Description of the Related Technology

Optical information recording media such as CD-R, DVD+R, and Blu-ray Disc have a structure in which a recording layer and a reflective layer are formed on a light-transmitting substrate having a diameter of 12 cm or 8 cm. Among these media, CD-R includes a recording layer and a reflective layer formed on a light-transmitting substrate having a thickness of 1.2 mm, while in DVD+R, a recording layer and a reflective layer are formed on a first light-transmitting substrate having a thickness of 0.6 mm in order to realize high-density recording. Therefore, DVD+R is formed by bonding a second light-transmitting substrate of the same shape having a thickness of 0.6 mm to the first light-transmitting substrate in order to conform to the thickness of CD-R.

In these optical information recording media, the surface opposite to the surface irradiated with a laser beam is generally used as a label surface on which a character, a symbol, a figure, a pattern, or a combination thereof is displayed by printing. In some cases, a printable layer may be provided on the surface in order to permit printing of an image or character by an ink jet printer.

Such optical information recording media are capable of easily forming images or characters on the label surfaces by printing. However, in order for images or characters, an exclusive apparatus or a corresponding apparatus is required. Therefore, there has recently been proposed a technique of drawing on an optical information recording medium with a laser beam. For example, Japanese Unexamined Patent Application Publication Nos. 2002-203321 and 2000-173096 propose an optical information recording medium in which a region (layer) capable of drawing by laser irradiation is formed on a label surface, thereby permitting easy drawing using the optical information recording medium. Japanese Unexamined Patent Application Publication No. 2003-051118 proposes that a portion of a data recording region is assigned to a region for drawing an image or character, thereby permitting information recording and drawing without the optical information recording medium being reversed in drawing.

The above-mentioned proposals have the following problems: In Japanese Unexamined Patent Application Publication Nos. 2002-203321 and 2000-173096, the drawing region is opposite to the information recording surface, and thus it is necessary to reverse the optical information recording medium in drawing. In addition, in drawing with the optical information recording medium, it is necessary to specify a laser irradiation position on the basis of a method for detecting positional information, such as LPP (Land-Pre-Pit) or ADIP (Address-In-Pre-Groove). However, the label surface does not include such a positional information detecting method, and it is necessary to provide the method on the label surface. In Japanese Unexamined Patent Application Publication No. 2003-051118, a portion of the data recording region is used for drawing, and thus it is necessary to prevent interference between data recording and drawing. Therefore, the data recording region and the drawing region are limited.

### SUMMARY OF CERTAIN INVENTIVE ASPECTS

Certain inventive aspects provide an optical information recording medium capable of drawing using the optical information recording medium without being reversed and without interference with a data recording region.

One aspect relates to an optical information recording medium including a recording layer and a first semitransparent reflective layer which are formed in order on one of the surfaces of a first light-transmitting substrate, wherein a discoloration layer is formed on the side on which the recording layer and the first semitransparent reflective layer are formed. The term “discoloration” represents a change in optical properties (reflection, absorption, and refraction of light) and includes “color fading” in which a color dilutes due to a decrease in light absorption and “color disappearance” in which a color disappears.

One aspect also provides an optical information recording medium in which a second light-transmitting substrate is bonded, through an adhesive layer, to the side of the first light-transmitting substrate on which the recording layer and the first semitransparent reflective layer are formed.

In an embodiment of the present invention, in the optical information recording medium, the discoloration layer is formed on the side of the first light-transmitting substrate on which the recording layer and the first semitransparent reflective layer are formed, and the second light-transmitting substrate is bonded to the discoloration layer through an adhesive layer.

In another embodiment of the present invention, in the optical information recording medium, one of the surfaces of the second light-transmitting substrate is bonded, through an adhesive layer, to the side of the first light-transmitting substrate on which the recording layer and the first semitransparent reflective layer are formed, and a second semitransparent reflective layer and a discoloration layer are formed in order on the other surface of the second light-transmitting substrate. In this case, a helical groove for recording positional information of the rotational direction may be formed on the side of the second light-transmitting substrate on which the second semitransparent reflective layer and the discoloration layer are formed.

Another aspect relates to an optical information recording medium including a first semitransparent reflective layer, a recording layer, and a light-transmitting layer which are formed in order on one of the surfaces of a first light-transmitting substrate, wherein a second semitransparent reflective layer and a discoloration layer are formed on the other surface of the first light-transmitting substrate.

Another aspect further provides a method of displaying on an optical information recording medium including a recording layer and a first semitransparent reflective layer which are formed in order on one of the surfaces of a first light-transmitting substrate, and a discoloration layer formed on the side of the first light-transmitting substrate opposite to the light incidence surface side thereof, the method including applying a laser beam to the discoloration layer from the same side as the side irradiated with a laser beam in information recording to provide a display on the optical information recording medium. The laser irradiation of the recording layer and the laser irradiation of the discoloration layer may be performed at the same time.

In one aspect, a laser beam for drawing can be applied from the same side as that of a laser beam for data recording, thereby permitting drawing with the optical information recording medium without the optical information recording medium being reversed. Also, an existing positional information detecting method such as LPP or ADIP can be used as a method for detecting positional information in drawing, and thus a new positional information detecting method need not be provided on a label surface. Further, a data recording region and a drawing region can be separated, thereby obtaining an optical information recording medium capable of drawing without interference with the data recording region.

### BRIEF DESCRIPTION OF THE DRAWINGS

FIG. 1 is a schematic sectional view showing an optical information recording medium according to a first embodiment of the present invention;

FIG. 2 is a schematic sectional view showing the operation of the optical information recording medium shown in FIG. 1;

FIG. 3 is a schematic sectional view showing an optical information recording medium according to a second embodiment of the present invention;

FIG. 4 is a schematic sectional view showing an optical information recording medium according to a third embodiment of the present invention; and

FIG. 5 is a schematic sectional view showing an optical information recording medium according to a fourth embodiment of the present invention.

### DETAILED DESCRIPTION OF CERTAIN EMBODIMENTS

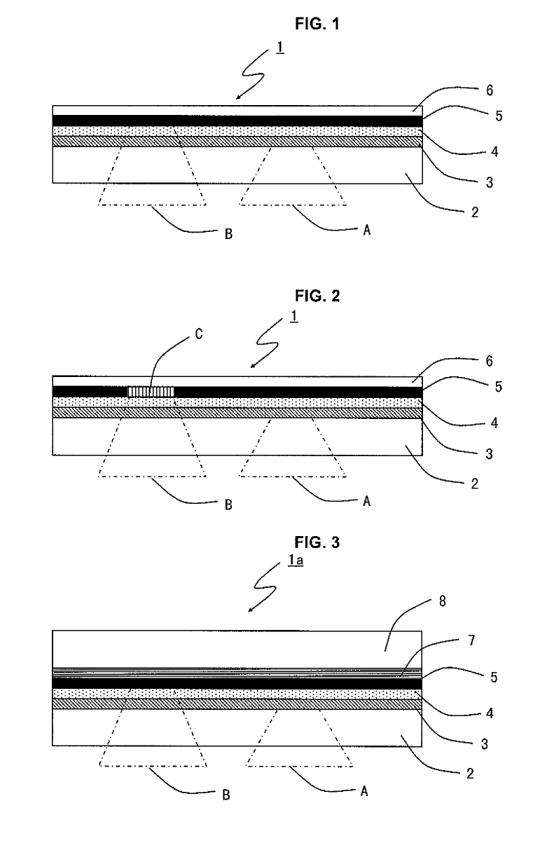

An optical information recording medium according to a first embodiment of the present invention will be described on the basis of FIGS. 1 and 2. FIG. 1 is a schematic sectional view of an optical information recording medium 1 of this embodiment. The optical information recording medium 1 has a structure in which a recording layer 3, a first semitransparent reflective layer 4, a discoloration layer 5, and a protective layer 6 are formed in order on a first light-transmitting substrate 2. The protective layer is optionally formed. In the drawings, a laser beam for recording or reproduction is shown by a one-dot chain line A, and a laser beam for drawing is shown by a one-dot chain line B.

The first light-transmitting substrate 2 is composed of a transparent resin such as polycarbonate and formed in a predetermined shape (a doughnut-like shape for an optical disc) by a method such as injection molding. The recording layer 3 contains an organic dye and is irradiated with a laser beam at a predetermined wavelength to form pits and record data. As the dye used in the recording layer 3, an azo dye or cyanine dye is preferred. The first semitransparent reflective layer 4 reflects the laser beam A for reproduction and transmits the laser beam B for drawing. As a material of the first semitransparent reflective layer 4, a metal (Ag, an Ag alloy, or Al) or a dielectric multi-layer film including oxide films having different refractive indexes may be used.

The discoloration layer 5 is formed using a material which is changed in optical properties by irradiation with the laser beam for drawing. Examples of such a material include a material which is changed in its structure by laser beam irradiation, and a material which is changed in interaction between a colorant composed of a dye and a developer for developing a color in the colorant. Examples of the former material include heat-sensitive dyes and photosensitive dyes, such as azo dyes and cyanine dyes. Examples of the latter material include materials using a leuco dye as the colorant and an organic material containing a hydroxyl group or a carboxyl group as the developer. As the leuco dye, a dye having a fluoran skeleton and a lactone ring is preferred. As the organic material containing a hydroxyl or carboxyl group, phenol or an organic acid such as benzoic acid or a derivative thereof is preferred. The discoloration layer 5 colored by mixing of the colorant and the developer is easily changed in interaction by laser beam irradiation to change the color. The protective layer 6 is formed using a transparent resin such as an acrylic UV curable resin, an epoxy UV curable resin, or a solvent-soluble polymer resin.

The method of drawing on the optical information recording medium 1 constituted as described above will be described on the basis of FIG. 2. The laser beam B for drawing is applied from the same direction as that of the laser beam A for recording. The laser beam B is transmitted through the first semitransparent reflective layer 4 and is applied to the discoloration layer 5 to change the optical properties of the material constituting the discoloration layer 5. As a result, a discolored portion C occurs in the discoloration layer 5, and an image is visualized by the formation of the discolored portion C.

Now, description will be made of the operation when the discoloration layer 5 is colored by interaction between a colorant and a developer. The discoloration layer 5 assumes a black color due to interaction between the colorant and the developer. When the laser beam B for drawing is applied, protons migrate to disappear or reduce the interaction between the colorant and the developer. As a result, the black color disappears, and the discoloration layer 5 seems colorless. The disappearance or reduction of the interaction is caused by, for example, disappearance of the developer due to sublimation or evaporation or crystallization of the colorant or the developer.

The recording layer 3 is formed in a region separate from the discoloration layer 5, thereby preventing interference therebetween. Since the laser beam A applied to the recording layer 3 and the laser beam B applied to the discoloration layer 5 have different focal lengths, it is possible to prevent interference by focal control even when the laser beams at the same wavelength are used. For caution's sake, the recording layer 3 and the discoloration layer 5 may have different light absorption properties (absorbance). In this case, a difference in absorbance peak may be 75 nm, preferably 100 nm or more, and more preferably 125 nm. For example, in the case of DVD, the wavelength of a laser beam for recording is generally about 660 nm, and thus a laser beam for drawing at a wavelength of 785 nm can be used.

Next, an optical information recording medium according to a second embodiment of the present invention will be described on the basis of FIG. 3. An optical information recording medium 1a shown in FIG. 3 includes, instead of a protective layer, a second light-transmitting substrate 8 bonded through an adhesive layer 7. DVD±R and HD-DVD have such a structure in order to match with the thickness of CD-R or the like. The drawing method is the same as in the first embodiment. The adhesive layer 7 includes an epoxy adhesive.

In an optical information recording medium such as DVD±R having the above-mentioned structure, DVD-R has a positional information detecting method such as LPP (not shown) and DVD+R has a positional information detecting method such as ADIP (not shown). Since an optical disc is rotated in drawing with a laser beam, laser irradiation is performed on the basis of positional information. Therefore, the positional information detecting method is required. However, in one embodiment, the laser beam for data recording and the laser beam for drawing can be applied from the same direction, and thus the existing positional information detecting method such as LPP or ADIP can be used.

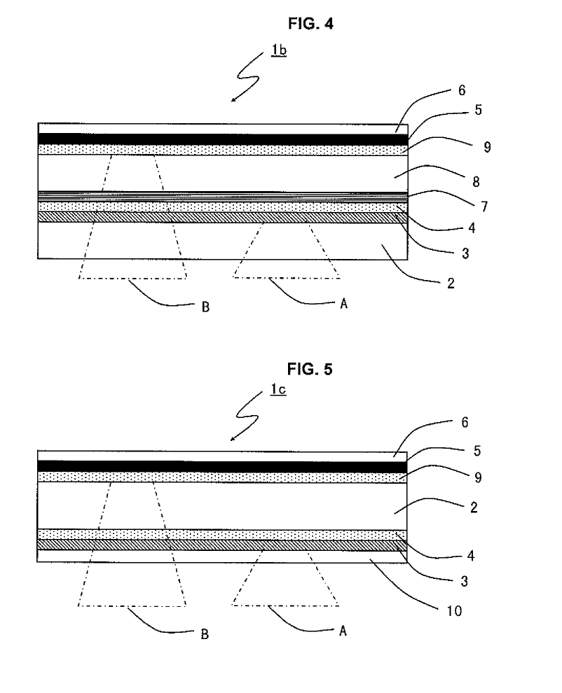

Next, an optical information recording medium according to a third embodiment of the present invention will be described on the basis of FIG. 4. An optical information recording medium 1b shown in FIG. 4 includes a recording layer 3 and a first semitransparent reflective layer 4 which are formed on a first light-transmitting substrate 2, and a second light-transmitting substrate 8, a second semitransparent reflective layer 9, a discoloration layer 5, and a protective layer 6 which are formed in order on the first light-transmitting substrate 2 through an adhesive layer 7.

In this structure, the second light-transmitting substrate 8 is provided between the recording layer 3 and the discoloration layer 5, and thus the effect of drawing without interference with the data recording region can be more improved. Also, in this structure, the laser beam applied to the recording layer 3 and the laser beam applied to the discoloration layer 5 have greatly different focal lengths. Therefore, for example, a laser beam for CD-R recording can be used as the laser beam applied to the discoloration layer 5, and thus a light source different from that for the laser beam applied to the recording layer 3 can be used. The second semitransparent reflective layer 9 is used for focusing the drawing laser beam B on the discoloration layer 5. Namely, in this embodiment, the second semitransparent reflective layer 9 is provided because the discoloration layer 5 and the first semitransparent reflective layer 4 are separated to fail to focus the laser beam by reflection from the first semitransparent reflective layer 4 unlike in the first and second embodiments. The second semitransparent reflective layer 9 may be the same as the first semitransparent reflective layer 4 or appropriately different in transmission wavelength or reflection wavelength.

A recording device capable of recording on both DVD±R and CD-R, i.e., a multi-drive, is provided with a laser source for DVD±R and a laser source for CD-R in some cases. When such a multi-drive is used, data recording on the recording layer 3 and drawing on the discoloration layer 5 can be performed using both light sources. This can be realized by a soft ware for controlling the recording device.

Further, a helical groove (not shown) having positional information of the rotational direction may be formed on the side of the second light-transmitting substrate 8 on which the second semitransparent reflective layer 9 and the discoloration layer 5 are formed. This can impart positional information for drawing. Since detailed positional information can be imparted as compared with the method of obtaining positional information using LPP or ADIP, a higher-definition image can be drawn. The positional information recorded in the helical groove can be read by light irradiation from the laser irradiation side.

Next, an optical information recording medium according to a fourth embodiment of the present invention will be described on the basis of FIG. 5. An optical information recording medium 1c shown in FIG. 5 has the structure of a so-called Blu-ray Disc in which a first semitransparent reflective layer 4 and a recording layer 3 are formed in order on one of the surfaces of a first light-transmitting substrate 2 having a thickness of 1.1 mm, and a polycarbonate light-transmitting layer 10 having a thickness of 0.1 mm is formed on the first light-transmitting substrate 2. In addition, a second semitransparent reflective layer 9, a discoloration layer 5, and a protective layer 6 are formed in order on the other surface of the first light-transmitting substrate 2.

In this structure, the recording layer 3 and the discoloration layer 5 are separated, thereby permitting drawing without interference with the data recording region. Also, in this structure, the laser beam applied to the recording layer 3 and the laser beam applied to the discoloration layer 5 have greatly different focal lengths. Therefore, for example, a laser beam for CD-R recording can be used as the laser beam applied to the discoloration layer 5, and thus a light source different from that for the laser beam applied to the recording layer 3 can be used, thereby permitting data recording and drawing at the same time. Further, a groove having positional information for data recording may be formed on the light incidence surface side of the first light-transmitting substrate 2, and positional information for drawing may be formed on the side opposite to the light incidence surface side.

Although the embodiments of the present invention are described above, the shape of an optical information recording medium is not limited within the range of the present invention, and the present invention can be applied to any shape.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not by itself be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. An optical information recording medium comprising:
a recording layer and a first semitransparent reflective layer which are formed in order on one of the surfaces of a first light-transmitting substrate,
wherein a discoloration layer is formed on the side on which the recording layer and the first semitransparent reflective layer are formed.

2. The optical information recording medium according to claim 1, wherein the discoloration layer is formed on or above the first semitransparent reflective layer.

3. The optical information recording medium according to claim 1, wherein a second light-transmitting substrate is bonded, through an adhesive layer, to the side of the first light-transmitting substrate on which the recording layer and the first semitransparent reflective layer are formed.

4. The optical information recording medium according to claim 3, wherein the second light-transmitting substrate is bonded to the discoloration layer through an adhesive layer.

5. The optical information recording medium according to claim 3, wherein one of the surfaces of the second light-transmitting substrate is bonded, through an adhesive layer, to the side of the first light-transmitting substrate on which the recording layer and the first semitransparent reflective layer are formed, and a second semitransparent reflective layer and the discoloration layer are formed in order on the other surface of the second light-transmitting substrate.

6. The optical information recording medium according to claim 5, wherein a helical groove for recording positional information of a rotational direction is formed on the side of the second light-transmitting substrate on which the second semitransparent reflective layer and the discoloration layer are formed.

7. The optical information recording medium according to claim 1, wherein the discoloration layer comprises a heat-sensitive dye or photo-sensitive dye.

8. The optical information recording medium according to claim 1, wherein the discoloration layer comprises a colorant and a developer for developing a color in the colorant, wherein the interaction between the colorant and the developer changes in response to laser beam irradiation.

9. An optical information recording medium comprising:
a first semitransparent reflective layer, a recording layer, and a light-transmitting layer which are formed in order on one of the surfaces of a first light-transmitting substrate,
wherein a second semitransparent reflective layer and a discoloration layer are formed on the other surface of the first light-transmitting substrate.

10. A method of forming an image on an optical information recording medium comprising a recording layer and a first semitransparent reflective layer which are formed in order on a first side of a first light-transmitting substrate, and a discoloration layer formed on the first side of the first light-transmitting substrate, the method comprising:
applying a laser beam to the discoloration layer from the same side as the side irradiated with a laser beam in information recording to form an image on the optical information recording medium.

11. The method according to claim 10, wherein the laser irradiation of the recording layer and the laser irradiation of the discoloration layer are performed at the same time.

12. The method according to claim 10, wherein the applying of a laser beam further comprises:
detecting positional information using a method used in data recording.

13. An optical information recording medium comprising:
a recording layer formed on or over a first substrate;
a first semitransparent reflective layer formed on or over the recording layer; and
a discoloration layer formed on or over the first semitransparent reflective layer.
